(19) United States
(12) Patent Application Publication
(10) Pub. No.: US 2003/0118314 A1
(43) Pub. Date: Jun. 26, 2003

(54) Variable optic attenuator

(76) Inventors: Chung-Chih Wang, Tu-Chen (TW); Yao-Hao Chang, Tu-Chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/032,082

(22) Filed: Dec. 21, 2001

(51) Int. Cl. G02B 6/26

(52) U.S. Cl. 385/140

(57) ABSTRACT

A variable optic attenuator includes a carrier movable in a longitudinal direction and a variable neutral density filter mounted to the carrier. A stepping motor is drivingly coupled to the carrier for reciprocally moving the filter. The carrier is coupled to a variable electric resistor for generating a feedback signal for controlling the stepping motor. A mount defines a channel in which the filter moves. The mount has two reference surfaces perpendicular to each other and 45 degree inclined with respect to the primary direction. Two mirrors are securely attached to the reference surfaces. The mount defines two bores parallel to the longitudinal direction. The bores receive and retain input and output optic fibers in precise alignment with the mirrors. A passage is formed between the mirrors and extends in a lateral direction perpendicular to the longitudinal direction and further extends through the filter. The bores, the mirrors and the passage form a substantially U-shaped optic path between the input and output fibers whereby an optic signal transmitted into the attenuator through the input fiber passes through one of the bores and is reflected by one of the mirrors to travel along the passage, through the filter, to the other mirror and is then redirected through the other bore to the output fiber. The optic signal is attenuated by the filter with different extents of attenuation determined by the relative position of the filter with respect to the passage.

### BACKGROUND OF THE INVENTION

1. Field of the Invention

The present invention generally relates to the field of optic attenuator and more particular to a variable optic attenuator employing a U-shaped optic path.

2. The Related Arts

Conventional reflector-based optic attenuator usually comprise reflectors for changing traveling directions of optic signals. Incident angles to the reflectors are adjusted so as to causes a slight misalignment of the optic signal and with respect to an output fiber thereby bring down coupling efficiency between the optic signals and the output fiber and thus attenuating the optic signals. Changing the misalignment leads to different coupling efficiency and thus different extents of attenuation.

The adjustment of the incident angle is done by means of electric motors, such as servo motor and stepping motor. However, such mechanical devices are not good in fine adjustment of the incident angle.

Another way to attenuate optic signals is to employ a variable neutral density filter having a variable filter density. An optic path is formed between input fiber and output fiber with the filter disposed in the optic path. Optic signals transmitted between the input and output fibers are attenuated by the filter and the attenuation is dependent upon the relative position of the filter with respect to the optic path, thereby achieving a variable attenuation.

The optic path between the input and output fibers for attenuating optic signals is commonly formed as a U-shape. Two reflectors are required. Conventionally, the reflectors are manually and individually adjusted to perfectly direct the optic signal from the input fiber to the output fiber. Such an adjustment is labor-consuming and costly and the productivity is low. Further, it is difficult to ensure quality of the attenuators in mass production.

It is thus desirable to provide a variable optic attenuator for overcoming the above discussed problems.

### SUMMARY OF THE INVENTION

Accordingly, an object of the present invention is to provide a variable optic attenuator which is easy to manufacture and has low manufacturing costs.

Another object of the present invention is to provide a variable optic attenuator comprises a mount having precisely formed reference surfaces to achieve precise arrangement of reflectors with respect to input and output fiber thereby ensuring proper operation and quality of the attenuator.

To achieve the above objects, a variable optic attenuator in accordance with the present invention comprises a carrier movable in a longitudinal direction and a variable neutral density filter mounted to the carrier. A stepping motor is drivingly coupled to the carrier for reciprocally moving the filter. The carrier is coupled to a variable electric resistor for generating a feedback signal for controlling the stepping motor. A mount defines a channel in which the filter moves. The mount has two reference surfaces perpendicular to each other and 45 degree inclined with respect to the primary direction. Two mirrors are securely attached to the reference surfaces. The mount defines two bores parallel to the longitudinal direction. The bores receive and retain input and output optic fibers in precise alignment with the mirrors. A passage is formed between the mirrors and extends in a lateral direction perpendicular to the longitudinal direction and further extends through the filter. The bores, the mirrors and the passage form a substantially U-shaped optic path between the input and output fibers whereby an optic signal transmitted into the attenuator through the input fiber passes through one of the bores and is reflected by one of the mirrors to travel along the passage, through the filter, to the other mirror and is then redirected through the other bore to the output fiber. The optic signal is attenuated by the filter with different extents of attenuation determined by the relative position of the filter with respect to the passage.

### BRIEF DESCRIPTION OF THE DRAWINGS

The present invention will be apparent to those skilled in the art by reading the following description of a preferred embodiment thereof, with reference to the attached drawings, in which:

FIG. 1 is a perspective view of a variable optic attenuator constructed in accordance with the present invention;

FIG. 2 is an exploded view of the variable optic attenuator of the present invention;

FIG. 3 is a top plan view of the variable optic attenuator of the present invention with a cover removed to show inside details;

FIG. 4 is a cross-sectional view schematically showing an optic path formed by the variable optic attenuator in accordance with the present invention;

FIG. 5 is an exploded view of an attenuating device of the variable optic attenuator in accordance with the present invention;

FIG. 6 is an exploded view of an optic module of the variable optic attenuator in accordance with the present invention;

FIG. 7 is a perspective view of a mount of the optic module shown in FIG. 6;

FIG. 8 is an assembled view of FIG. 6;

FIG. 9 is a cross-sectional view taken along line IX-IX of FIG. 3; and

FIG. 10 is a partial assembled view of the variable optic attenuator in accordance with the present invention.

### DETAILED DESCRIPTION OF THE PREFERRED EMBODIMENT

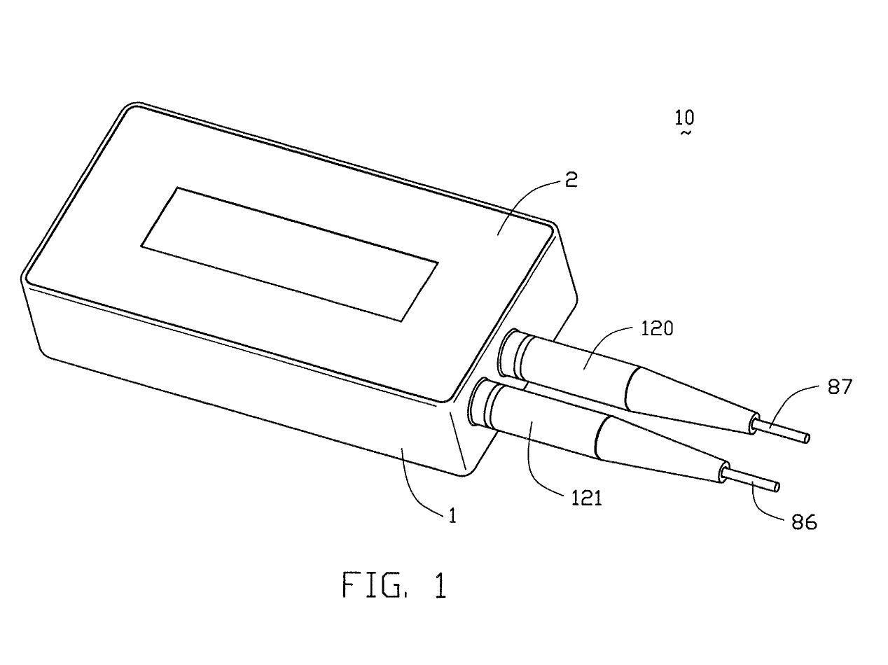

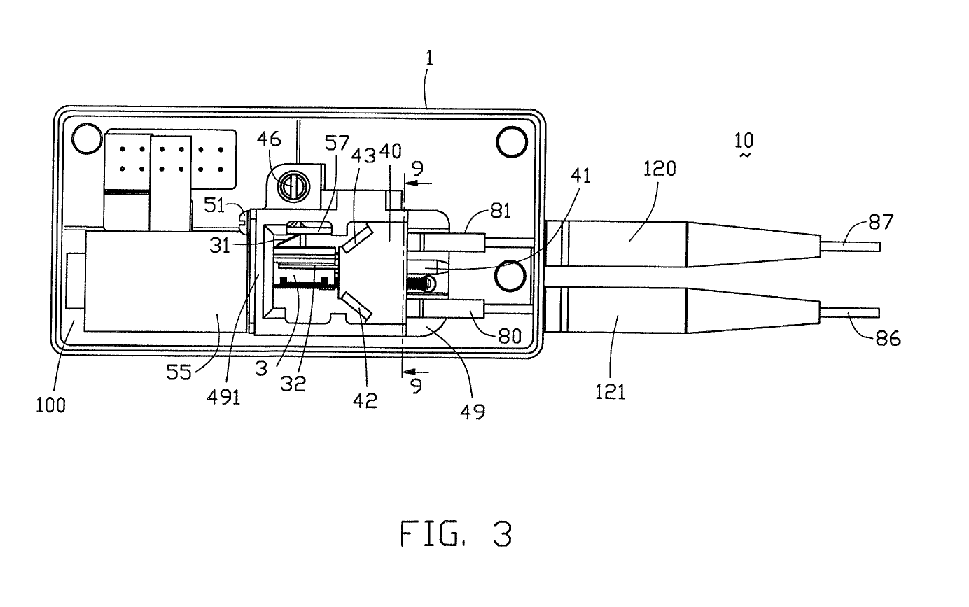

With reference to the drawings and in particular to FIG. 1, a variable optic attenuator constructed in accordance with the present invention, generally designated with reference numeral 10, comprises a casing 1 having an opening (not labeled) closed by a cover 2 defining an interior space 100 (FIG. 3) inside the casing 1. Input optic fiber 86 and output optic fiber 87 are respectively attached to the variable optic attenuator 10 for transmitting optic signals into and out of the attenuator 10.

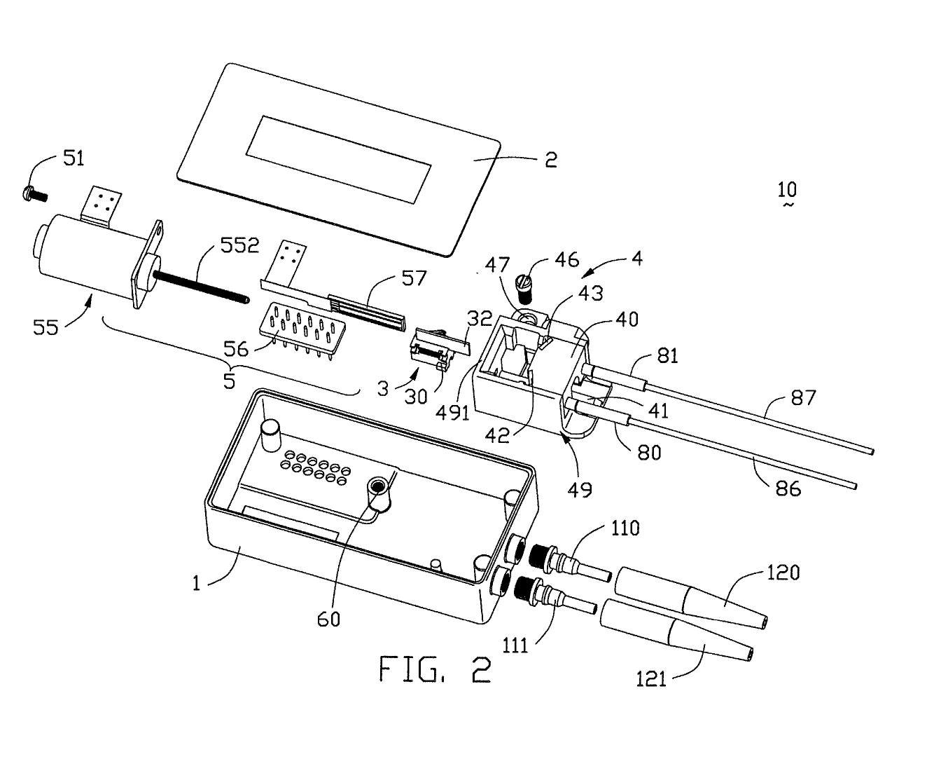

Also referring to FIGS. 2 and 3, an attenuating device 3, an optic module 4 and an electric control unit 5 are received and fixed in the interior space of the casing 1. The input and output optic fibers 86, 87 are respectively attached to the casing 1 by means of fiber retainers 111, 110 with an end of each optic fiber 86, 87 extending into the interior space of the casing 1. A boot 121, 120 is provided around each fiber retainer 111, 110 and a portion of the corresponding optic fiber 86, 87 for protection of the fibers 86, 87. The ends of the optic fibers 86, 87 are respectively connected to the optic module 4 by collimators 80, 81

The optic module 4 comprises a mount 40 received in and retained by a chassis 49 and first and second reflectors 42, 43, such as mirrors, attached to and supported by the mount 40. The first reflector 42 receives an optic signal from the input optic fiber 86 and reflects the signal to the second reflector 43 which then reflects the signal to the output optic fiber 87. The reflectors 42, 44 are arranged to form a U-shaped optic path between the input and output optic fibers 86, 87.

The attenuating device 3 is positioned between the reflectors 42, 43 and movable in a longitudinal direction substantially perpendicular to the optic path between the reflectors 42, 43. The attenuating device 3 comprises a carrier 30 carrying a variable neutral density filter 32 having an effective filtering zone through which optic signals transmitting along the optic path between the reflectors 42, 43 pass. The effective filtering zone has a filter density smoothly and gradually varies from a low density region to a high density region in a direction in which the carrier 30 moves, which in the embodiment illustrated is the longitudinal direction. Thus the optic signals passing through the filter 32 are attenuated to different extents in response to the movement of the carrier 30.

The electric control unit 5 is coupled to the carrier 30 of the attenuating means 3 for displacing the filter 32 with respect to the optic path between the reflectors 42, 43. The electric control unit 5 comprises an electric motor 55, such as a stepping motor, which is connected to an external power source (not shown) by a connection member 56. The motor 55 has a threaded output shaft 552 threadingly coupled to the carrier 30 of the attenuating device 3 whereby the filter 32 moves in response to the rotation of the threaded shaft 552. A variable electric resistor 57 is in physical engagement with the carrier 30 and powered via the connection member 56. A feedback signal is generated by the variable electric resistor 57 in accordance with the position of the filter 32 with respect to the optic path between the reflectors 42, 43. The feedback signal is fed to a control circuit (not shown) of the motor 55 for controlling the rotation of the threaded shaft 552.

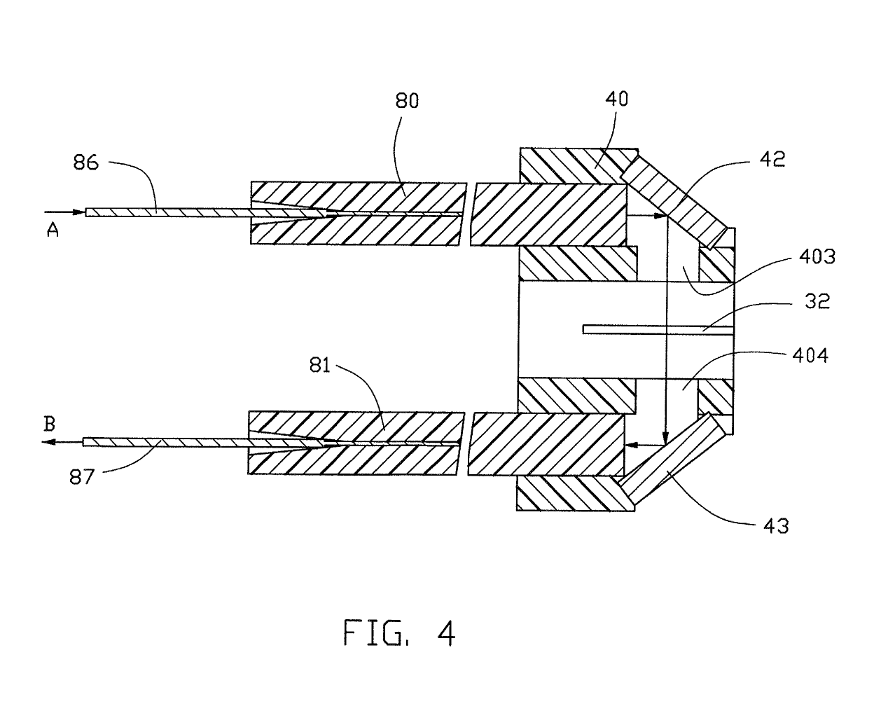

Also referring to FIG. 4, the U-shaped optic path formed between the input and output fibers 86, 87 is shown. An input optic signal (arrow A) is transmitted via the input fiber 86 to the collimator 80 which projects the signal to the first reflector 42. The signal is then reflected by the first reflector 42, passing through the filter 32 of the attenuating device 3, toward the second reflector 43. The attenuated signal is incident onto the second reflector 43 and is then reflected by the second reflector 43 toward the collimator 81 through which the attenuated signal (arrow B) is transmitted to the output fiber 87. The position of the filter 32 relative to the optic path between the reflectors 42, 43 determines the attenuation of the signal as mentioned previously.

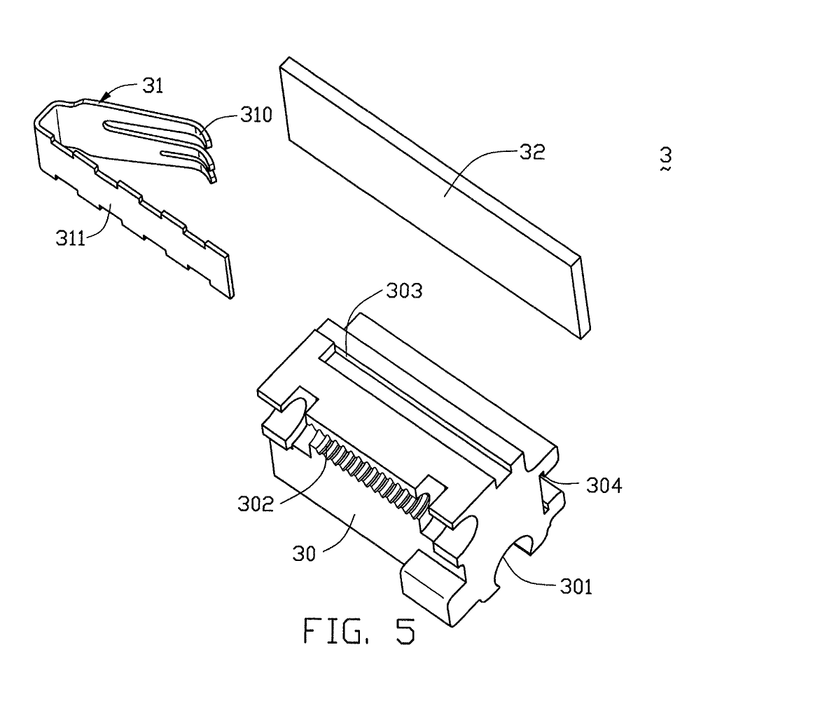

Also referring to FIG. 5, the carrier 30 of the attenuating device 3 defines a filter receiving slot 303 in which the filter 32 is received and retained. The carrier 30 also defines an inner-threaded bore or slot 302 with which the threaded shaft 552 of the motor 55 drivingly engages. A guide groove 301 is defined in the carrier 30 for slidingly receiving a guide rail 41 (see FIGS. 2, 3, 9 and 10) to guide the movement of the carrier 30. A slider 31 made of conductive materials comprises a fixing arm 311 interferentially fit into a slit 304 defined in the carrier 30 for securely attaching the slider 31 to the carrier 30 to move in unison therewith. The slider 31 has a spring arm 310 physically engages conductors (not shown) of the variable resistor 57 for generating the feedback signal discussed previously. It is apparent that the slider 31 can be attached to the carrier 30 by any other known means.

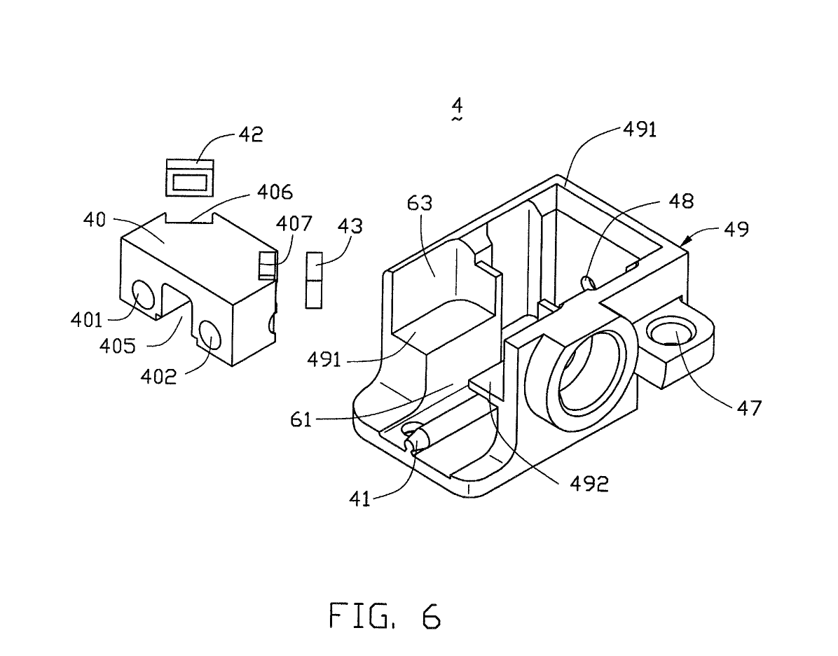

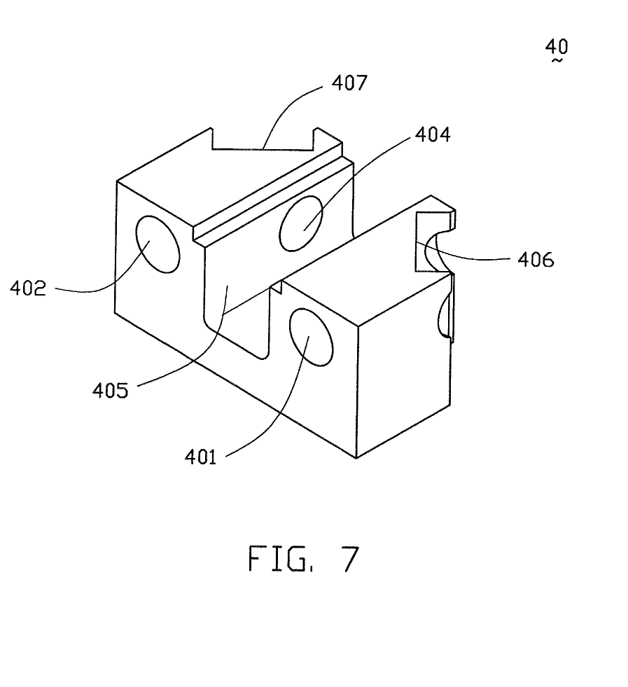

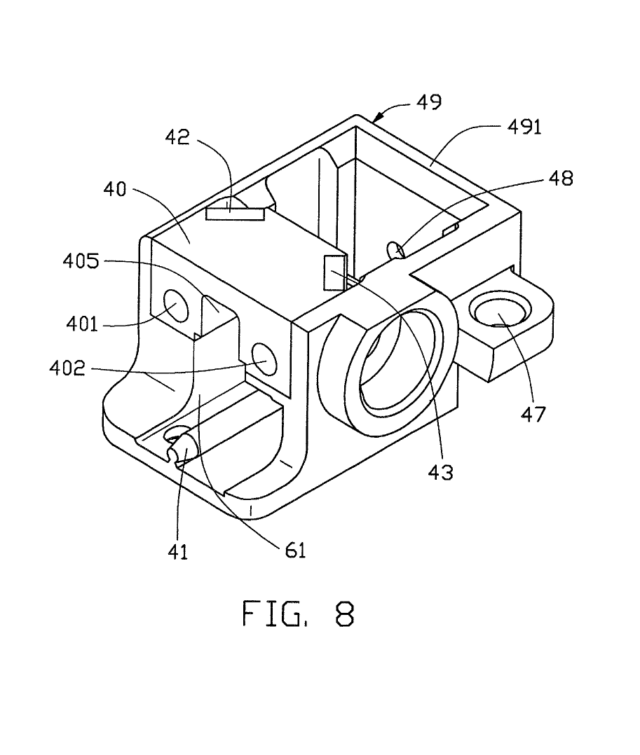

Also referring to FIGS. 6-8, the optic module 4 comprises a chassis 49 inside which the mount 40 is received and retained. The motor 55 is attached to an end wall 491 of the chassis 49 by for example a bolt 51 (FIGS. 2 and 3). The chassis 49, together with the motor 55, is fixed inside the casing 1 by a bolt 46 extending through a hole 47 defined in the chassis 49 and engaging an inner-threaded hole 60 (FIG. 2) defined in the casing 1. The chassis 49 forms a channel 61 along which the guide rail 41 extends. A through hole 48 is defined in the end wall 491 of the chassis 49 in communication with the channel 61 for the extension of the threaded shaft 552 of the motor 55 into the channel 61.

The channel 61 is defined between two platforms 491, 492 that are substantially flush with each other for supporting the mount 40. The mount 40 is configured to be snugly received in a cavity 63 defined in the chassis 49 and firmly supported by the platforms 491, 492.

The attenuating device 3 is movably received in the channel 61 of the chassis 49 with the carrier 30 threadingly engaging the threaded shaft 552 of the motor 55. A sliding but snug engagement is formed between the guide rail 41 of the chassis 49 and the guide groove 301 of the carrier 30 which helps suppression of vibration caused by the operation of the motor 55 on the carrier 30 thereby ensuring optical and mechanical stability of the attenuating device 3.

The mount 40 forms a central channel 405 which corresponds to and cooperates with the channel 61 of the chassis 49 to form a moving channel for the attenuating device 3. In the embodiment illustrated, the moving channel (61, 405) extends in the longitudinal direction thereby allowing the carrier 30 of the attenuating device 3 to move therealong in the longitudinal direction. Two notches (not labeled), each having a flat reference surface 406, 407, are formed in the mount 40 on opposite sides of the channel 405 for respectively receiving and retaining reflectors 42, 43.with the reflectors 42, 43 securely attached the reference surfaces 406, 407, such as by adhesives, for precisely positioning the reflectors 42, 43 with respect to the mount 40. In the embodiment illustrated, the reference surfaces 406, 407 are made 45 degree inclined with respect to the longitudinal direction and are perpendicular to each other.

Two primary bores 401, 402 are defined in the mount 40 on opposite sides of and parallel to the channel 405. Thus the primary bores 401, 402 extend in a direction parallel to the longitudinal direction through the mount 40 to be in communication with the notches. The primary bores 401, 402 receive the collimators 80, 81 therein and aligns the collimators 80, 81 with respect to the reflectors 42, 43. Aligned secondary bores 403, 404 (also see FIG. 4) extending in a lateral direction perpendicular to the longitudinal direction are defined in the mount 40 on opposite sides of the channel 405 and are respectively in communication with the notches thereby forming a passage extending across the channel 405. The secondary bores 403, 404 are perpendicular to the primary bores 401, 402. Each reference surface 406, 407 is located at the intersections of the corresponding primary bore 401, 402 and the secondary bore 403, 404 whereby light traveling through the primary bore 401 is incident to the first reflector 42 and reflected thereby to pass through the secondary bores 403, 404 toward the second reflector 43 and then reflected to the collimator 81 through the primary bore 402. A U-shaped optic path is thus formed between the collimators 80, 81 as shown in FIG. 4.

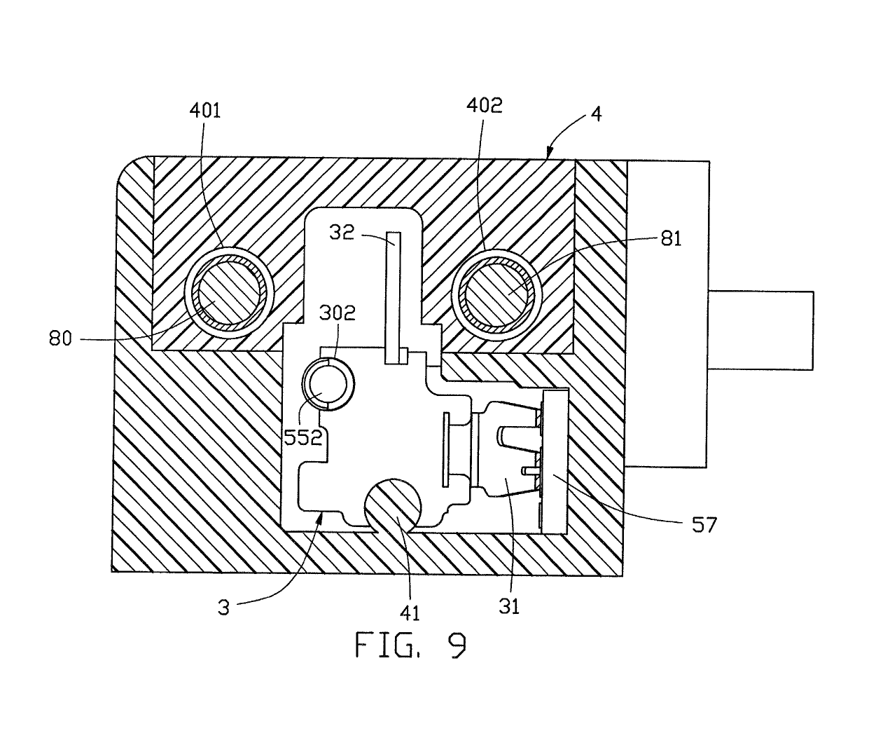

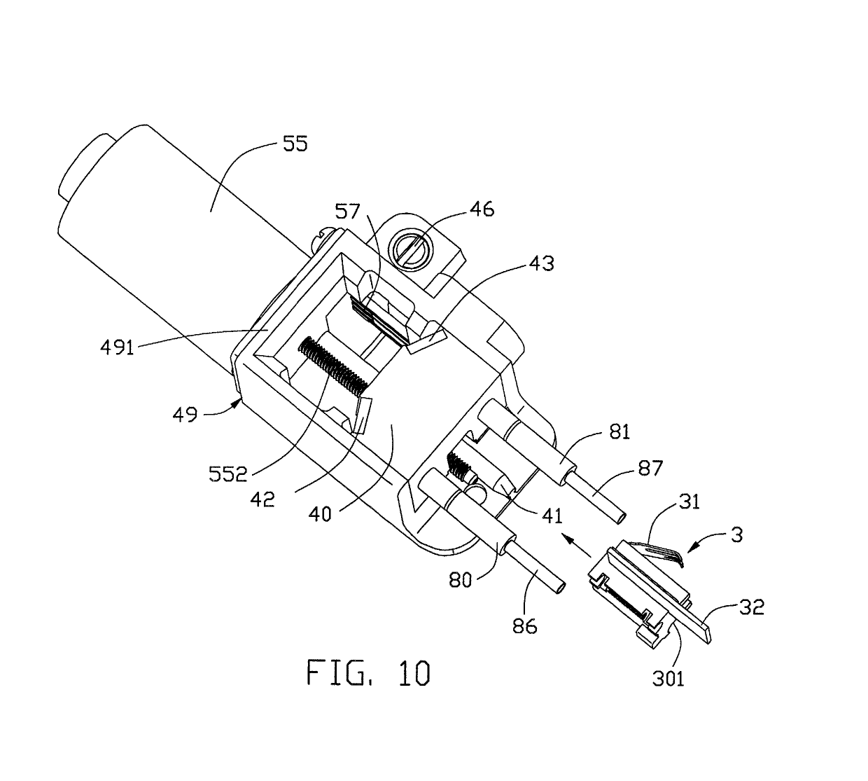

As shown in FIGS. 9 and 10, the attenuating device 3 is movably arranged inside the optic module 4. The threading 302 of the carrier 30 drivingly engages the threaded shaft 552 of the motor 55. for linearly moving the carrier 30 along the guide rails 41 in the longitudinal direction. The spring arm 310 of the slider 31 physically engages the variable resistor 57 that is securely fixed to an inside surface of the chassis 49 for providing the feedback signal to the motor 55. When the attenuating device 3 is moved with the threaded shaft 552, the filter 32 that is fixed to the carrier 30 is reciprocally displaced and optic signals passing along the passage formed by the secondary bores 403, 404 through the filter 32 is attenuated to different extents, depending the position or displacement of the filter 32 with respect to the optic module 4. Thus, a variable attenuation can be achieved by driving the motor 55 to move the filter 32.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A variable optic attenuator comprising:
a chassis defining a channel extending in a first direction;
an attenuating device movably received in the channel, the attenuating device comprising a filter having a density varying from a low density region to a high density region in a filter moving direction that is substantially parallel to the first direction;
a driving unit mechanically coupled to the attenuating device for reciprocally moving the filter in the filter moving direction;
a mount attached to the chassis, the mount forming first and second primary bores extending parallel to the first direction and located on opposite sides of the channel, and a passage extending across the channel in a second direction perpendicular to the first direction and intersecting the first and second primary bores, the mount forming first and second flat surfaces at the intersection of the passage with the first and second primary bores, the surfaces being 45 degree inclined with respect to the first direction and perpendicular to each other, first and second reflectors being attached to the first and second flat surfaces of the mount;
wherein the filter is located in the passage and thus between the reflectors, the movement of the filter by the driving unit bring different regions of the filter to the passage; and
wherein the first and second bores primary are adapted to receive and retain ends of input optic fiber and output optic fiber, an optic signal transmitted through the input optic fiber is incident to the first reflector through the first primary bore and is then reflect to pass through filter along the passage toward the second reflector which reflects the signal to the output optic fiber through the second primary bore thereby forming a U-shaped optic path between the input and output optic fibers.

2. The variable optic attenuator as claimed in claim 1, wherein the attenuating device comprises a carrier to which the filter is attached and wherein the driving unit comprises an electric motor drivingly coupled to the carrier for reciprocating the filter in the filter moving direction.

3. The variable optic attenuator as claimed in claim 2, wherein the coupling between the motor and the carrier comprises a threaded shaft rotated by the motor and an inner threading formed in the carrier, a threading engagement being formed between the threaded shaft and the threading of the carrier.

4. The variable optic attenuator as claimed in claim 2, wherein the driving unit comprises electric control means comprising a variable resistor, a conductive member being attached to the carrier to be movable therewith, the conductive member having a spring arm physically engaging the variable resistor to generate a feedback signal to the electric control means.

5. The variable optic attenuator as claimed in claim 2, wherein the carrier defines a guide groove slidingly and receivingly engaging a guide rail formed inside the channel of the chassis.

6. The variable optic attenuator as claimed in claim 1, wherein the chassis forms platforms on opposite sides of the channel for supporting the mount with the first and second primary bores of the mount located on opposite sides of the channel.

7. The variable optic attenuator claimed in claim 4, wherein the electric motor is a stepping motor in connection with the electric control means, the feedback signal being fed to the electric control means for controlling the stepping motor.

8. The variable optic attenuator as claimed in claim 1, wherein the reflectors comprise mirrors attached to the flat surfaces by adhesives.

9. A variable optic attenuator comprising:
an attenuating device comprising a filter movable in a longitudinal direction;
an electric control unit drivingly coupled to the attenuating device for reciprocally moving the filter in the longitudinal direction; and
an optic module comprising a mount having two reference surfaces perpendicular to each other, two reflectors securely attached to the reference surfaces, the mount further defining two parallel primary bores adapted to receive and retain input and output optic fibers in precise alignment with the reflectors, a passage being formed between the reflectors and extending in a lateral direction not parallel to the primary direction and through the filter whereby the primary bores, the reflectors and the passage form a substantially U-shaped optic path between the input and output fibers.

10. The variable optic attenuator as claimed in claim 9, wherein the attenuating device comprises a carrier to which the filter is attached, and wherein the electric control unit comprises a stepping motor drivingly coupled to the carrier for moving the filter in the longitudinal direction.

11. The variable optic attenuator as claimed in claim 10, wherein the stepping motor comprises a threaded output shaft extending in the primary direction and threadingly engaging with an inner threading of the carrier for moving the carrier and the filter in the longitudinal direction.

12. The variable optic attenuator as claimed in claim 9, wherein the electric control unit comprises a variable electric resistor and wherein the attenuating device comprises a slider electrically and movably engaging the variable electric resistor for generating a feedback signal to control the stepping motor.

13. The variable optic attenuator as claimed in claim 10, wherein the optic module having a wall to which the motor is attached, a though hole being defined in the wall for extension of the threaded shaft of the motor.

14. The variable optic attenuator as claimed in claim 9, wherein the attenuating device forms a guiding groove and wherein the optic module comprises a guide rail movably received in the guiding groove for guiding the reciprocal movement of the attenuating device.

15. The variable optic attenuator as claimed in claim 9, wherein the optic module comprises first and second platforms for supporting the mount.

16. The variable optic attenuator as claimed in claim 9, wherein the mount defines a channel between the primary bores with the attenuating device movably received in the channel.

17. The variable optic attenuator as claimed in claim 16, wherein the passage consists of first and second secondary bores defined in the mount, aligned with each other and respectively located on opposite sides of the channel.

18. The variable optic attenuator as claimed in claim 9, wherein the reference surfaces are 45 degree inclined with respect to the primary bores and the passage.

19. The variable optic attenuator as claimed in claim 9, wherein the reflectors comprise mirrors attached to the reference surfaces by adhesives.

20. An optic module comprising:
a chassis;
a mount disposed in on portion of said chassis, said mount defining parallel first and second primary bores extending along a first direction with a channel therebewteen, a passage extending cross the channel in a second direction perpendicular to said first direction and intersecting the first and second primary bores, a pair of reflectors respectively located at an intersection of the first and the second primary bore and the passage, each of said reflectors facing to the corresponding primary bore and the passage at forty five degrees;
a carrier movably mounted in the other portion of said chassis along said first direction, said carrier bringing a filter intersecting said passage; and
an electrical resistor disposed in the chassis engaged with a slider which moves along with the carrier.
